(19) United States
(12) Patent Application Publication
(10) Pub. No.: US 2011/0020773 A1
(43) Pub. Date: Jan. 27, 2011

(54) APPARATUS FOR TRAINING IN THE USE OF CHOPSTICKS

(75) Inventor: Chien Chiang Sung, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: INTERNATIONAL INVENTION INC., Vancouver, BC (CA)

(21) Appl. No.: 12/934,055

(22) PCT Filed: Mar. 28, 2008
(86) PCT No.: PCT/CA2008/000592

§ 371 Date: Sep. 22, 2010

(51) Int. Cl. G09B 19/00

(52) U.S. Cl. 434/127

(57) ABSTRACT

A chopsticks training apparatus has a guide having first and second ends. An indentation is provided at or near the first end of the guide. The guide has at least one surface extending between the first and second ends and forming an elongate channel. The user positions a distal tip of a first chopstick in the indentation and a distal tip of a second chopstick in the channel. With the distal tip of the first chopstick held stationary in the indentation, the user practices moving the second chopstick so that its distal tip moves away from and toward the distal tip of the first chopstick while being guided by the surfaces of the channel.

### TECHNICAL FIELD

This invention relates to apparatus for training a person to use a pair of chopsticks.

### BACKGROUND

Chopsticks are used as eating utensils in many parts of the world. As seen in FIG. 1, a pair of chopsticks 9 (comprising first and second chopsticks 10, 12) are held by the fingers of a hand 8 and may be maneuvered to pick up or otherwise manipulate pieces of food. Generally, first and second chopsticks 10, 12 are grasped at locations which are closer to proximal ends 24, 26 of chopsticks 10, 12 than to distal tips 20, 22 of chopsticks 10, 12. The precise locations at which first and second chopsticks 10, 12 are held vary according to the sizes of the hand and fingers relative to chopsticks 10, 12.

As shown in FIG. 1, to hold a pair of chopsticks 9 for use as an eating utensil, first chopstick 10 is typically cradled between the base of thumb 14 and the side of palm 19 at the base of forefinger 15. First chopstick 10 is also typically braced against the upper joint of ring finger 17. Second chopstick 12 is typically held between the tip of thumb 14 and middle finger 16. A pad of forefinger 15 typically rests on the top of chopstick 12.

In operation, first chopstick 10 is held generally stationary relative to hand 8, while thumb 14, forefinger 15 and middle finger 16 cooperate to move second chopstick 12 so that its distal tip 22 moves toward and/or away from distal tip 20 of first chopstick 10. By moving second chopstick 12 in this way, distal tips 20, 22 can be positioned for grasping or otherwise manipulating a piece of food and carrying it to a desired location (e.g. a mouth or to another dish).

The use of a pair of chopsticks as an eating utensil can be learned by observing and emulating others using chopsticks, and/or by receiving instruction from those who are accomplished in the skill. With practice and guidance, one may eventually master the skill of holding and using a pair of chopsticks.

However, it may not always be practical or possible to observe others using chopsticks or to receive instruction from those learned in the skill of using chopsticks. Also, without the guidance or assistance of a tutor, one may become frustrated at his or her own attempts to use a pair of chopsticks. For example, one often experiences difficulties holding one chopstick stationary while moving a distal tip of the other chopstick toward and/or away from a distal tip of the stationary chopstick.

There is a general desire for an apparatus to assist one to learn how to use a pair of chopsticks or to improve one's ability in using a pair of chopsticks.

### BRIEF DESCRIPTION OF DRAWINGS

In drawings which illustrate non-limiting embodiments of the invention:

FIG. 1 is a perspective view of a hand holding a pair of chopsticks;

FIG. 2 is an isometric view of an apparatus for training in the use of chopsticks according to one embodiment of the invention;

FIGS. 3A and 3B are perspective views of the FIG. 2 apparatus, shown with a pair of chopsticks at different positions relative to the apparatus;

FIGS. 4 and 5 are perspective views of an apparatus for training in the use of chopsticks according to another embodiment of the invention; and

FIG. 6 is a perspective view of a pair of chopsticks which may be used with the apparatus of FIGS. 2, 4 and/or 5.

### DESCRIPTION

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

This invention provides apparatus for training a person to use a pair of chopsticks. Particular embodiments of the invention provide apparatus which may be used to guide the person in holding and positioning the chopsticks. The apparatus may incorporate: a chopstick-retention element for retaining a distal tip of a first chopstick; and a guide comprising at least one guide surface extending between a first end located proximate the chopstick-retention element and a second end spaced apart from the chopstick-retention element. The guide may serve to guide a distal tip of a second chopstick in a path between a first position wherein the distal tips of the first and second chopsticks are relatively close to one another and a second position wherein the distal tips of the first and second chopsticks are relatively spaced apart from one another.

The chopstick-retention element may comprise an indentation. The guide may comprise an elongate channel extending between the first and second ends. The channel may be curved along its length. The apparatus may comprise a base for supporting the guide on a level surface.

To use the guide, the user holds the first and second chopsticks with the fingers of one hand (as described above). The user places the distal tip of the first chopstick in the chopstick-retention element and the distal tip of the second chopstick in or against the guide. With the distal tip of the first chopstick held stationary in the chopstick-retention element, the user practices moving the second chopstick so that its distal tip moves away from and/or toward the distal tip of the first chopstick while being guided by the guide. The guide constrains the motion of the second chopstick and prevents the distal tip of the second chopstick from moving in an undesired manner.

In other embodiments, the apparatus has a chopstick-retention element for retaining a distal tip of a first chopstick. Formed along an outer side of the apparatus, and spaced apart from the chopstick-retention element, is a recessed portion shaped for receiving a distal tip of a second chopstick when the first and second chopsticks are almost parallel to one another (and therefore the distal tips of the first and second chopsticks are proximate one another). With the distal tip of the first chopstick held stationary in the chopstick-retention element, the user practices moving the second chopstick so that its distal tip moves away from the distal tip of the first chopstick, and subsequently toward the distal tip of the first chopstick until the distal tip of the second chopstick is positioned in the recessed portion of the apparatus.

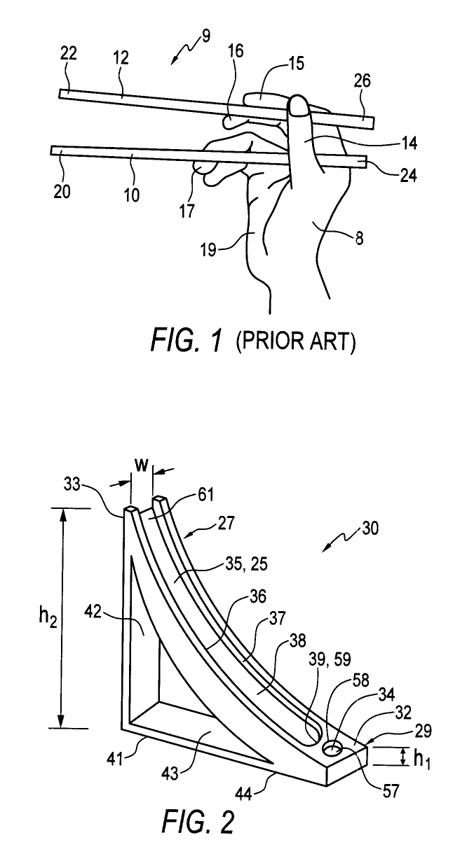

FIG. 2 illustrates an apparatus 30 for training a person in the use of chopsticks according to a particular embodiment of the invention. Apparatus 30 may be used with a pair of chopsticks 9 consisting of first and second chopsticks 10, 12 (FIG. 1). Apparatus 30 comprises a chopstick-guide portion 27, a chopstick-retention portion 29 and a base 41 for supporting chopstick-guide portion 27 and chopstick-retention portion 29. Chopstick-retention portion 29 is located at or near a first end 32 of apparatus 30 and chopstick-guide portion 27 extends between chopstick-retention portion 29 and a second end 33 of apparatus 30. In the illustrated embodiment, chopstick-retention portion 29 incorporates an indentation 34 for receiving distal tip 20 of first chopstick 10 as explained in more detail below. Chopstick-guide portion 27 incorporates a guide 25 for guiding the movement of second chopstick 12 as discussed further below. In the illustrated embodiment, guide 25 comprises an elongate channel 35 which extends between second end 33 and indentation 34 of chopstick-retention portion 29. Channel 35 may have a height h₁ at its first end 59, and a height h₂ at its second end 61. Height h₂ may be larger than height h₁.

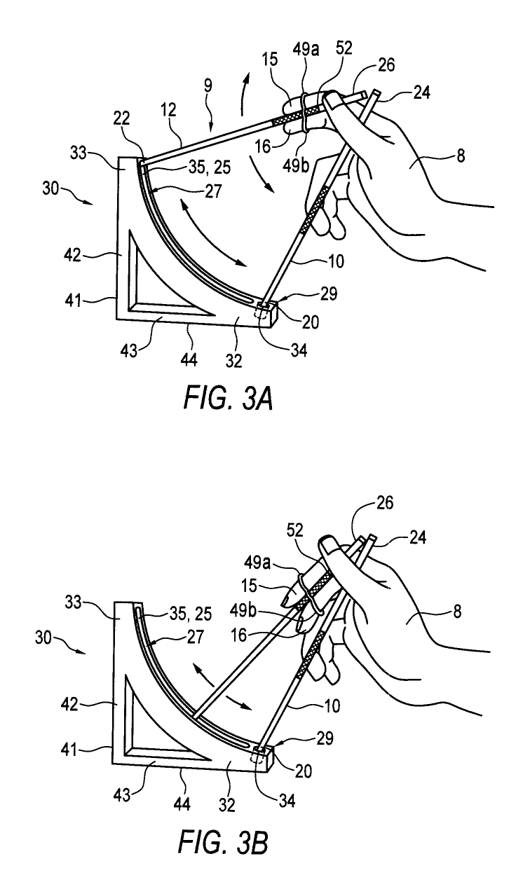

Indentation 34 of chopstick-retention portion 29 may be sized for receiving distal tip 20 of first chopstick 10. In some embodiments, indentation 34 has a diameter (or width) which is generally between 1.1 and 2 times larger than a cross-sectional dimension of distal tip 20 of first chopstick 10. Indentation 34 may be defined by a lower surface 57 and a wall portion 58 extending from lower surface 57. In use, lower surface 57 of indentation 34 may be oriented generally perpendicularly to first chopstick 10, and wall portion 58 of indentation 34 may be oriented generally parallel to first chopstick 10 (see FIGS. 2, 3A and 3B). In some embodiments, indentation 34 is provided with a cross-sectional shape that is substantially similar to the cross-sectional shape of distal tip 20 of first chopstick 10. For example, in the illustrated embodiment of FIGS. 2, 3A and 3B, indentation 34 has a generally circular lower surface 57 and a generally cylindrical wall portion 58 to accommodate a rounded distal tip 20 of first chopstick 10. In other embodiments, indentation 34 may be rectangular in shape and defined by a rectangular lower surface 57 and a four-sided wall portion 58 extending from lower surface 57.

Given that first chopstick 10 is generally held by hand 8 at an incline with respect to the vertical, indentation 34 may be oriented at a suitable incline to accommodate the inclined position of first chopstick 10. For example, lower surface 57 defining indentation 34 may be at an incline with respect to undersurface 44 of base 41. In some embodiments, the angle between lower surface 57 and undersurface 44 is between 5 and 45 degrees.

Indentation 34 has a depth such that distal tip 20 will not readily slip from indentation 34 while distal tip 20 is positioned in indentation 34. In some embodiments, the depth of indentation 34 is between 2 mm and 10 mm.

Channel 35 may be curved along its length for receiving and guiding distal tip 22 of second chopstick 12 in a curved path as it is moved away from and toward distal tip 20 of first chopstick 10. In the illustrated embodiment, channel 35 is defined in part by a pair of elongate opposed sidewalls 36, 37 for restraining transverse movement of second chopstick 12. Channel 35 may also be defined in part by an elongate base surface 38 extending transversely between sidewalls 36, 37. Sidewalls 36, 37 are spaced apart by a transverse width w which is greater than a cross-sectional dimension of distal tip 22 of second chopstick 12. Width w can be selected to accommodate some transverse movement of distal tip 22. However, if distal tip 22 strays too far, transversely, from the path defined by channel 35, distal tip 22 will abut against one of sidewalls 36, 37. In some embodiments, a ratio of width w to a cross-sectional dimension of distal tip 22 of second chopstick 12 may be in the range of 1.1 to 1.5. In some embodiments, width w may be between 8 mm and 15 mm to accommodate distal tip 22 of second chopstick 12 having a cross-sectional dimension which is within a typical range for chopsticks. Channel 35 may have a depth (defined by a height of sidewalls 36, 37 extending from base surface 38) which may be between 2 mm and 8 mm in some embodiments.

First end 59 of channel 35 may be defined by an end wall 39 extending transversely between sidewalls 36, 37 at a location proximate indentation 34. End wall 39 may be spaced apart from indentation 34 by a distance which permits distal tips 20, 22 of first and second chopsticks 10, 12, to be positioned close to one another when distal tip 20 is placed in indentation 34 and distal tip 22 abuts against end wall 39 within channel 35. In some embodiments, the distance between end wall 39 and the nearest part of wall portion 58 defining indentation 34 is between 3 mm and 10 mm.

Second end 61 of channel 35 may be located at or near second end 33 of apparatus 30. In the illustrated embodiment, second end 61 of channel 35 is left open. In other embodiments, an end wall may be provided to extend between sidewalls 36, 37 at second end 61 of channel 35.

Apparatus 30 may incorporate a base 41 for supporting chopstick-guide portion 27 and chopstick-retention portion 29. In the illustrated embodiment of FIGS. 2, 3A and 3B, base 41 comprises a first support 42 extending generally downwardly at second end 33 of apparatus 30. Base 41 also has a second support 43 extending generally horizontally between first end 32 of apparatus 30 and a lower part of first support 42. Second support 43 has an undersurface 44 for resting apparatus 30 against a level surface such as a table, floor, etc. In the illustrated embodiment, base 41 (including first and second supports 42, 43) is integrally formed with chopstick-guide portion 27 and chopstick-retention portion 29. In other embodiments, base 41 may be provided as a separate component which may be coupled to chopstick-guide portion 27 and/or chopstick-retention portion 29. Base 41 may have a shape different than that described herein, while still providing a support for chopstick-guide portion 27 and chopstick-retention portion 29. For example, base 41 may comprise a plurality of legs or generally vertical wall pieces, or a solid triangular piece having a level undersurface, or any other suitable configuration for supporting chopstick-guide portion 27 and chopstick-retention portion 29.

FIGS. 3A and 3B illustrate apparatus 30 with a pair of chopsticks 9 held at different positions in the course of using apparatus 30. In operation, first and second chopsticks 10, 12 are held with the fingers of hand 8 as shown in FIG. 1. Distal tip 20 of first chopstick 10 is placed in indentation 34 and remains there throughout (FIGS. 3A and 3B). Distal tip 22 of second chopstick 12 is placed in channel 35. Initially, chopsticks 10, 12 may be positioned almost parallel to one another, with distal tip 22 of second chopstick 12 abutting against end wall 39 (or located close to end wall 39) at first end 59 of channel 35.

To practice using chopsticks 10, 12, the fingers of hand 8 cooperate to move second chopstick 12 so that its distal tip 22 moves away from distal tip 20 of first chopstick 10 in a curved path while remaining within channel 35. Distal tip 22 of second chopstick 12 may reach a location which is spaced apart from distal tip 20 of first chopstick 10, as seen in FIG. 3A. Subsequently, the fingers of hand 8 may cooperate to move second chopstick 12 so that its distal tip 22 moves back toward distal tip 20 of first chopstick 10 (FIG. 3B). As distal tip 22 of second chopstick 12 moves away from and toward distal tip 20 of first chopstick 10, distal tip 22 of second chopstick 12 is guided in a curved path by sidewalls 36, 37 and base surface 38 of channel 35.

While second chopstick 12 is being moved by the fingers of hand 8, first chopstick 10 is held stationary and distal tip 20 of first chopstick 10 maintains its position in indentation 34. Indentation 34 acts as a bracing point for distal tip 20 of first chopstick 10, helping to prevent movement of distal tip 20.

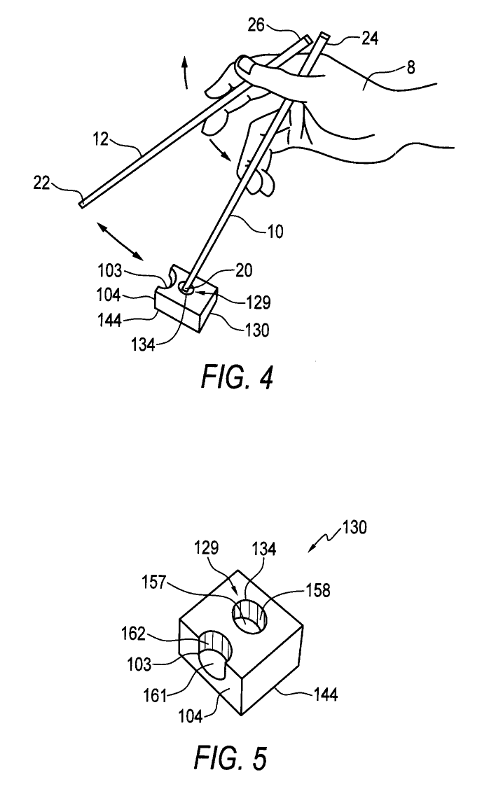

FIG. 4 illustrates an apparatus 130 for training a person in the use of chopsticks according to another embodiment of the invention. Apparatus 130 is similar in some respects to apparatus 30, and similar reference numerals are used herein to refer to the similar features, except that features of apparatus 130 have the leading digit “1” (e.g. indentation 134 of apparatus 130 is similar to indentation 34 of apparatus 30).

In the illustrated embodiment, apparatus 130 has a flat undersurface 144 for resting apparatus 130 on a level surface. Apparatus 130 incorporates a chopstick-retention portion 129 which comprises an indentation 134 formed therein. Indentation 134 may have characteristics similar to, and function in a manner similar to, indentation 34 of apparatus 30 described above. As with apparatus 30, distal tip 20 of first chopstick 10 is positioned in indentation 134 and remains there while second chopstick 12 is being moved.

Unlike guide 30, apparatus 130 does not have an elongate guide 25 or channel 35 for guiding distal tip 22 of second chopstick 12 as it moves away from and toward distal tip 20 of first chopstick 10. Rather, apparatus 130 has a recessed portion 103 formed at an outer side 104 of apparatus 130 and spaced apart from indentation 134. Recessed portion 103 may be shaped for receiving at least a portion of distal tip 22 of second chopstick 12. In some embodiments, recessed portion 103 may be shaped to conform to a portion of the shape of distal tip 22 of second chopstick 12. For example, in the illustrated embodiment of FIGS. 4 and 5, recessed portion 103 is defined by a semicircular lower surface 161 and a semicylindrical wall portion 162 extending generally perpendicularly from lower surface 161 to accommodate second chopstick 12 having a round cross-section.

In operation, first and second chopsticks 10, 12 are held with the fingers of hand 8 as shown in FIG. 1. Distal tip 20 of first chopstick 10 is placed in indentation 134 of apparatus 130 and remains there throughout. Distal tip 22 of second chopstick 12 may initially be positioned at recessed portion 103 of apparatus 130, with surfaces of distal tip 22 abutting against lower surface 161 and wall portion 162 of recessed portion 103. Recessed portion 103 is located proximate to indentation 134 such that when chopsticks 10, 12 are held in the above-described initial position, first and second chopsticks 10, 12 are almost parallel to one another.

To practice using chopsticks 10, 12, the fingers of hand 8 cooperate to move second chopstick 12 so that its distal tip 22 moves away from and toward distal tip 20 of first chopstick 10. As distal tip 22 is making its return trip toward distal tip 20, the user can aim to move distal tip 20 toward recessed portion 103 so that surfaces of distal tip 20 eventually abut against surfaces of recessed portion 103.

While second chopstick 12 is being moved by the fingers of hand 8, distal tip 20 of first chopstick 10 may be braced against the surfaces of indentation 134. Indentation 134 helps to keep chopstick 10 steady by retaining distal tip 20 of first chopstick 10 in one location.

Both apparatus 30, 130 may be used as components of a system for training a person to use a pair of chopsticks 9. For example, when initially practicing the use of chopsticks 9, apparatus 30 may be used to practice moving distal tip 22 of second chopstick 12 along a path in channel 35, while holding distal tip 20 of first chopstick 10 steady in indentation 34. When the user becomes more skilled in holding and maneuvering chopsticks 10, 12 with the assistance of apparatus 30, the user may switch to apparatus 130. With apparatus 130, the user may practice maneuvering distal tip 22 of second chopstick 12 away from and toward distal tip 20 of first chopstick 10 without the assistance of a guide channel. However, indentation 134 is still provided in apparatus 130 to assist with steadying distal tip 20 of chopstick 10. Eventually, after sufficient practice with apparatus 30 or apparatus 130, the user can practice holding and maneuvering chopsticks 10, 12 without the use of apparatus 30 or apparatus 130.

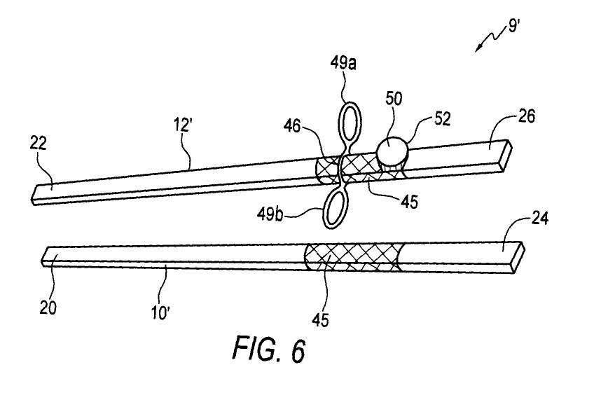

In some embodiments, a pair of chopsticks may optionally be adapted for use with apparatus 30, 130 in practicing the use of chopsticks. As best seen in FIG. 6, a pair of chopsticks 9′, which comprise first and second chopsticks 10′, 12′ each having an optional finger marking 45, may be used with apparatus 30, 130. Finger marking 45 may comprise a section of each chopstick 10′, 12′ which is coloured, textured or otherwise marked to indicate the approximate location at which fingers of hand 8 should grip or contact the chopstick.

Finger gripping bands 49a, 49b (FIGS. 3 and 6) may be attached to second chopstick 12′ at opposed sides of second chopstick 12′ to assist a user in securely gripping chopstick 12′ while chopsticks 10′, 12′ are being manipulated. Gripping bands 49a, 49b may have outer surfaces comprising rough material, elastomeric material or otherwise slip-resistant material. Gripping bands 49a, 49b may be coupled to an attachment band 46 which encircles chopstick 12′ at a location spaced apart from proximal end 26. In use (FIGS. 3A and 3B), the tip of forefinger 15 of hand 8 is inserted in gripping band 49a and the tip of middle finger 16 of hand 8 is inserted in gripping band 49b. Gripping bands 49a, 49b help to retain forefinger 15 and middle finger 16 in their position on second chopstick 12′ while the user is practicing moving second chopstick 12′ relative to first chopstick 10′. To accommodate different finger positions or sizes, the position of gripping bands 49a, 49b may be adjusted by sliding and/or rotating attachment band 46 relative to second chopstick 12′. In some embodiments, gripping bands 49a, 49b may be positioned on forefinger 15, middle finger 16, respectively, at a location between a tip and an upper joint of the finger. Gripping bands 49a, 49b may be located relatively closer to the tip of each finger than to the upper joint of each finger.

In some embodiments, attachment band 46 may comprise a cylindrical band or sleeve having a first end relatively more proximate to proximal end 26 of second chopstick 12′ and a second end relatively more proximate to distal tip 22 of second chopstick 12′. Gripping band 49a may be coupled to attachment band 46 at its first end for receiving a tip of forefinger 15. Gripping band 49b may be coupled to attachment band 46 at its second end for receiving a tip of middle finger 16.

A protrusion 50 may be located on second chopstick 12′ on one side of marking 45 toward proximal end 26 of second chopstick 12′ (FIG. 6). Protrusion 50 may be attachable to second chopstick 12′ by any suitable means (e.g. adhesive) or, in other embodiments, protrusion 50 may be integrally formed as a bump, ridge, etc. of second chopstick 12′. Protrusion 50 may act as a placement indicator or a brace for thumb 14 of hand 8. When second chopstick 12′ is held by hand 8, a side of thumb 14 abuts against a side 52 of protrusion 50 which is closest to proximal end 26 of second chopstick 12′.

The embodiments of the chopsticks training apparatus described herein may be fabricated from any suitable rigid or semi-rigid material(s), such as, by way of non-limiting example, plastic, wood, metal, foam, ceramics.

The dimensions of the chopsticks training apparatus described herein may be sized to accommodate different hand sizes and different lengths of chopsticks. For example, a smaller apparatus may be used for training young children in the use of chopsticks which are shorter in length than those typically used by adults.

Although only the right hand is illustrated in the drawings, the embodiments of the chopsticks training apparatus described herein may be used for training in the use of chopsticks with either a right hand or a left hand.

Apparatus 30, 130 may be provided as components of a kit for training in the use of chopsticks. The kit may also include one or more of the following:
finger gripping bands 49a, 49b and attachment band 46 (which may be provided as one integral piece for attachment to second chopstick 12);
first and second chopsticks 10, 12 which may include finger markings 45;
protrusion 50 (or an extra chopstick 12 provided with protrusion 50);
variously shaped or textured objects which a user can practice picking up and moving, using chopsticks 10, 12.

While a number of exemplary aspects and embodiments have been discussed above, those of skill in the art will recognize certain modifications, permutations, additions and sub-combinations thereof. For example:
In the illustrated embodiment described above, chopstick-retention portions 29, 129 incorporate an indentation 34 for retaining distal tip 20 of first chopstick 10. In other embodiments, chopstick-retention portions 29, 129 may be provided with other tip-retaining element(s). By way of non-limiting example, as an addition to or alternative to indentation 34, chopstick-retention portion 29 may incorporate any of the following tip-retaining element(s) to retain distal tip 20 of first chopstick 10: one or more upwardly extending walls; a tip locking mechanism; adhesive material(s); and/or suitable fasteners.
In the illustrated embodiment, indentation 34 is shaped to completely surround distal tip 20 of first chopstick 10. This is not necessary. In general, it is not necessary to restrain motion of distal tip 20 of first chopstick 10 in a direction away from second chopstick 12. Accordingly, indentation 34 does not require completely closed sidewalls 58. Other additional or alternative tip retaining features may be similarly modified.
In the illustrated embodiment described above, guide 25 of chopstick-guide portion 27 incorporates a three-sided channel 35 which is generally U-shaped in cross-section. This is not necessary. For example, base surface 38 of channel 35 is not required. In some embodiments, guide 25 may comprises a pair of sidewalls 36, 37 for constraining transverse motion of tip 22 of second chopstick 12 without a base surface 38. While providing guide 25 with a pair of sidewalls 36, 37 constrains transverse motion of tip 22 of second chopstick 12 in both transverse directions, this is not necessary for learning to use chopsticks 10, 12. In some embodiments, guide 25 may comprise a single guide surface in the place of sidewalls 36, 37. Such a guide surface can be elongated generally in the direction of motion of second chopstick 12. Such a guide surface can still help to teach a user to use chopsticks 10, 12 by allowing the user to exert pressure (via second chopstick 12) against the guide surface. Guide of embodiments incorporating such a guide surface may or may not incorporate a base surface 38.
In the embodiments described above, the surfaces which define channel 35 (i.e. sidewalls 36, 37 and base surface 38) are curved. This is not necessary. In other embodiments, any of these surfaces may be straight or may comprises series of straight portions oriented at angles with respect to one another. Similarly, in embodiments where guide 25 comprises a single guide surface in the place of sidewalls 36, 37, such a guide surface may be curved, may be straight or may comprise a series of portions oriented at angles with respect to one another.
In the embodiments described above, channel 35 comprises an end wall 39 at its first end 59. This is not necessary. In some embodiments, channel 35 has no end wall 39. Rather, channel 35 may extend into chopstick-retention portion 29 and possibly into indentation 34. In such embodiments, indentation 34 may have a depth which is greater than a depth of channel 35 at its first end 59.
Undersurfaces 44, 144 may be provided with friction-enhancing material (e.g. an elastomeric material) to minimize slippage during use of apparatus 30, 130.
   It is therefore intended that the following appended claims and claims hereafter introduced are interpreted to include all such modifications, permutations, additions and sub-combinations as are within their true spirit and scope.

1. An apparatus for training a user to use a pair of chopsticks, the apparatus comprising:
a chopstick-retention element for retaining a distal tip of a first chopstick; and
a guide comprising at least one guide surface extending between a first end located proximate the chopstick-retention element and a second end spaced apart from the chopstick-retention element for guiding a distal tip of a second chopstick in a path between a first position wherein the distal tips of the first and second chopsticks are relatively close to one another and a second position wherein the distal tips of the first and second chopsticks are relatively spaced apart from one another.

2. An apparatus according to claim 1 wherein the chopstick-retention element comprises an indentation.

3. An apparatus according to claim 1 wherein the at least one surface is curved.

4. An apparatus according to claim 1 wherein the at least one surface comprises a pair of transversely spaced apart sidewalls extending between the first and second ends.

5. An apparatus according to claim 4 comprising a base surface extending transversely between the sidewalls, such that together the base surface and the sidewalls define an elongate channel.

6. An apparatus according to claim 5 wherein the sidewalls are transversely spaced apart by a width which is between 1.1 and 1.5 times larger than a cross-sectional dimension of the distal tip of the second chopstick.

7. An apparatus according to claim 5 wherein the base surface is curved along a length of the channel.

8. An apparatus according to claim 5 comprising an end wall extending transversely between the sidewalls to define a first end of the channel at a location adjacent to the chopstick-retention element.

9. An apparatus according to claim 2 wherein the indentation is defined by a lower surface and a wall portion extending from the lower surface.

10. An apparatus according to claim 9 wherein the lower surface of the indentation is oriented at an incline with respect to an undersurface of the apparatus.

11. An apparatus according to claim 9 wherein the indentation has a width which is between 1.1 and 2 times larger than a cross-sectional dimension of the distal tip of the first chopstick.

12. An apparatus according to claim 1 comprising a base for supporting the guide on a level surface.

13. An apparatus according to claim 12 wherein the base comprises a first support extending generally downwardly at the second end of the guide surface and a second support extending generally horizontally between the first end of the guide surface and a lower part of the first support.

14. An apparatus according to claim 1 wherein a height of the guide surface at the first end of the guide surface is less than a height of the guide surface at the second end of the guide surface.

15. An apparatus according to claim 1 wherein the chopstick-retention element comprises one or more of: one or more raised walls; a tip locking mechanism; adhesive material(s); and one or more suitable fasteners.

16. An apparatus according to claim 1 comprising finger gripping bands for attachment to the second chopstick at a first location spaced apart from a proximal end of the second chopstick.

17. An apparatus according to claim 16 wherein the finger gripping bands comprise first and second bands positionable on opposed sides of the second chopstick for retention of a middle finger and a forefinger of the user, respectively.

18. An apparatus according to claim 1 comprising a protrusion for attachment to the second chopstick at a second location spaced apart from the proximal end of the second chopstick for abutment against a thumb of the user.

19. An apparatus according to claim 1 wherein when the second chopstick is in the first position, the first and second chopsticks are almost parallel.

20. An apparatus for training a user to use a pair of chopsticks, the apparatus comprising:
a chopstick-retention element for retaining a distal tip of a first chopstick; and
a recessed portion proximate to but spaced apart from the chopstick-retention element, the recessed portion shaped to receive a portion of a distal tip of a second chopstick when the distal portion of the second chopstick moves from a location spaced apart from the distal tip of the first chopstick to a location proximate the distal tip of the first chopstick.

21. An apparatus according to claim 20 wherein the recessed portion is defined by a semicircular first lower surface and a semicylindrical first wall portion extending substantially perpendicularly from the first lower surface.

22. An apparatus according to claim 20 wherein the chopstick-retention element comprises an indentation.

23. An apparatus according to claim 22 wherein the indentation is defined by a second lower surface and a second wall portion extending from the second lower surface.

24. An apparatus according to claim 23 wherein the second lower surface of the indentation is oriented at an incline with respect to an undersurface of the apparatus.

25. An apparatus according to claim 22 wherein the indentation has a width which is between 1.1 and 2 times larger than a cross-sectional dimension of the distal tip of the first chopstick.

26. An apparatus according to claim 20 wherein when the distal tip of the second chopstick is in a location proximate the distal tip of the first chopstick, the first and second chopsticks are almost parallel.

27. An apparatus for training a user to use a pair of chopsticks, the apparatus comprising:
means for retaining a distal tip of a first chopstick; and
means for guiding a distal tip of a second chopstick in a path between a first position wherein the distal tips of the first and second chopsticks are relatively close to one another and a second position wherein the distal tips of the first and second chopsticks are relatively spaced apart from one another.
